(19) United States
(12) Patent Application Publication
(10) Pub. No.: US 2024/0353179 A1
(43) Pub. Date: Oct. 24, 2024

(54) FURNACE INCLUDING ELECTRICALLY POWERED HEATING ELEMENTS ARRANGED FOR UNIFORM HEATING AND RELATED METHODS

(71) Applicant: SABIC GLOBAL TECHNOLOGIES B.V., BERGEN OP ZOOM (NL)

(72) Inventors: Scott A. STEVENSON, Houston, TX (US); Michael Edward HUCKMAN, Houston, TX (US); Hongbing JIAN, Houston, TX (US)

(73) Assignee: SABIC GLOBAL TECHNOLOGIES B.V., BERGEN OP ZOOM (NL)

(21) Appl. No.: 18/682,781

(22) PCT Filed: Aug. 8, 2022
(86) PCT No.: PCT/EP2022/072199

§ 371 Date: Feb. 9, 2024

(30) Foreign Application Priority Data
Aug. 12, 2021 (EP) 21191022.9

(51) Int. Cl. F27D 99/00; F27D 1/00; F27D 11/02

(52) U.S. Cl. CPC F27D 99/0006; F27D 1/0036; F27D 11/02

(57) ABSTRACT

An electrically powered furnace may include a furnace housing and heating elements extending in the furnace housing. The furnace also may include heating tubes extending in the interior volume, and each of the heating tubes may define an interior passage positioned to receive and heat the feed as the feed passes through the interior passage. The heating tubes may be positioned in the furnace housing to receive heat radiated from the heating elements, and the heating tubes may be arranged in one or more of at least two rows or at least two columns and such that each of the heating tubes is substantially equidistant from three or more of the heating elements. A method may include supplying a feed to the heating tubes, heating the heating tubes via the heating elements, and heating the feed via as the feed passes through the heating tubes.

### TECHNICAL FIELD

The present disclosure relates to furnaces including electrically powered heating elements arranged for substantially uniform heating and related methods and, more particularly, to furnaces for heating a feed and including electrically powered heating elements arranged for substantially uniform heating of heating tubes and related methods.

### BACKGROUND

Some furnaces for heating a material may include two opposing walls and one or more columns of tubes positioned between the two opposing walls, and through which the material may pass during heating of the material. Each of the two opposing walls may provide a heat input to the tubes, for example, via gas-fired burners, and as the material to be heated passes through the tubes, heat is transferred from the tubes to the material.

Such furnaces may include a number of possible drawbacks. For example, because the tubes receive heat input from two opposing sides only, portions of the tubes adjacent the walls receive relatively more heat input than portions of the tubes not adjacent the walls. As a result, not all portions of the tubes are uniformly heated, which may result in non-uniform heating of the material passing through the tubes. Depending on the material being heated and the temperatures involved, this may lead to problems with the heated material or the tubes. In addition, because the heat input is provided only at the opposing walls, such furnaces may be only suitable for heating a single column of tubes, for example, because tubes farther from the walls and the heat input than tubes adjacent the walls would not receive the same heat input as tubes adjacent the walls. Thus, a disparity in heat input among the tubes would occur, which may present problems for the material being heated or the tubes. For example, in order to provide sufficient heat input for tubes farther from the walls, the tubes adjacent the walls would receive excess heat input, which may lead to overheating of the material or the tubes closest to the wall. Moreover, tubes closest to the walls would impede or block heat input to tubes farther from the walls, thereby potentially enhancing the disparity between the heat input to the tubes closest to the walls and the tubes farther from the walls. In addition, because only a single column of tubes is efficiently heated for each pair of opposing walls, increasing the heating capacity of such furnaces requires a relatively large amount of space. Also, because the ratio of wall area to interior volume is high, a large amount of refractory insulation may be required, and heat losses to the surroundings may be correspondingly larger than desired.

An attempt to provide improved heat transfer efficiency in the radiant section of a chemicals cracker by the use of radiants between the coils is described in U.S. Patent Application Publication No. US 2017/0137722 A1 to Petela et al. (“the '722 publication”). The '722 publication describes a substantially linear ceramic or metallic radiant of ellipsoidal or polygonal cross section placed proximate furnace tubes or coils in the radiant section of a fired heater to increase the radiant heat directed to the surface of the tubes or coils. According to the '722 publication, the radiant absorbs radiant heat from the furnace walls, combustion gases or both, and re-radiates it toward the furnace tube coils.

Applicant has recognized that the furnace and methods of '722 publication may still result in a need for systems and methods for heating materials that are more efficient and/or more environmentally friendly. For example, the radiants described in the '722 publication are passive, merely re-directing heat toward the furnace tubes or coils, thus limiting the effectiveness of the radiants. In addition, the '722 publication relates to furnaces including fired heaters, which may emit large amounts of carbon dioxide during operation. Thus, although the furnace and methods described in the '722 publication purport to provide gains in efficiency, they may still be less efficient than desired, and further, may still result in an undesirably high emission of carbon dioxide into the surrounding atmosphere during operation.

Accordingly, Applicant has recognized a need for furnaces and methods for providing substantially uniform heating and, more particularly, to furnaces for heating a feed and including electrically powered heating elements arranged for providing substantially uniform heating of heating tubes and related methods. The present disclosure may address one or more of the above-referenced drawbacks, as well as other possible drawbacks.

### SUMMARY

As referenced above, some furnaces may not provide sufficiently uniform heating and may lack efficiency of heating and use of space. The present disclosure is generally directed to electrically powered furnaces and related methods and, more particularly, to electrically powered furnaces for heating a feed and including electrically powered heating elements arranged for providing substantially uniform heating of heating tubes through which a material passes for heating the material. For example, in some embodiments, an electrically powered furnace may include a furnace housing including walls at least partially defining an interior volume and electrically powered heating elements extending in the interior volume. The furnace also may include heating tubes extending in the interior volume, each defining an interior passage positioned to receive a feed and heat the feed as the feed passes through the interior passage. The heating elements and the heating tubes may be arranged such that the heating elements and/or the heating tubes form a repeating pattern. At least some embodiments of the systems and methods to heat a feed disclosed herein may result in electrically powered furnaces that provide more uniformly heated heating tubes, providing a more uniformly heated feed material, and/or more efficient heating and use of space.

According to some embodiments, an electrically powered furnace to heat a feed may include a furnace housing including one or more housing walls at least partially defining an interior volume and a longitudinal housing axis. The furnace also may include a plurality of heating elements extending in the interior volume and between a first heating element end and a second heating element end. Each of the plurality of heating elements may be electrically powered to radiate heat. The furnace further may include a plurality of heating tubes extending in the interior volume and between a tube inlet end and a tube outlet end. Each of the plurality of heating tubes may define an interior passage positioned to receive the feed and heat the feed as the feed passes through the interior passage between the tube inlet end and the tube outlet end, and the plurality of heating tubes may be positioned in the furnace housing to receive heat radiated from the plurality of heating elements. The plurality of heating tubes may be arranged in one or more of at least two rows or at least two columns and such that each of the plurality of heating tubes is substantially equidistant from three or more of the plurality of heating elements. As used herein, “substantially equidistant” may mean plus or minus 20%.

According to some embodiments, a hydrocarbon heating assembly may include an electrically powered furnace, and the electrically powered furnace may include one of a steam cracking furnace, a steam methane reformer, a hydrocarbon heater for dehydrogenation, or any other hydrocarbon heating assembly with features as defined above. The electrically powered furnace may include a furnace housing including one or more housing walls at least partially defining an interior volume and a longitudinal housing axis. The furnace also may include a plurality of heating elements extending in the interior volume and between a first heating element end and a second heating element end. Each of the plurality of heating elements may be electrically powered to radiate heat. The furnace further may include a plurality of heating tubes extending in the interior volume and between a tube inlet end and a tube outlet end. Each of the plurality of heating tubes may define an interior passage positioned to receive the feed and heat the feed as the feed passes through the interior passage between the tube inlet end and the tube outlet end, and the plurality of heating tubes may be positioned in the furnace housing to receive heat radiated from the plurality of heating elements. The plurality of heating tubes may be arranged in one or more of at least two rows or at least two columns and such that each of the plurality of heating tubes is substantially equidistant from three or more of the plurality of heating elements.

According to some embodiments, a method to heat a feed may include supplying a feed to a plurality of heating tubes and heating the plurality of heating tubes via a plurality of heating elements. The plurality of heating tubes may be arranged in one or more of at least two rows or at least two columns and such that each of the plurality of heating tubes is substantially equidistant from three or more of the plurality of heating elements. The method further may include heating the feed via the plurality of heating tubes as the feed passes through the heating tubes.

Still other aspects and advantages of these exemplary embodiments and other embodiments are discussed in detail herein. Moreover, it is to be understood that both the foregoing information and the following detailed description provide merely illustrative examples of various aspects and embodiments, and are intended to provide an overview or framework for understanding the nature and character of the claimed aspects and embodiments. Accordingly, these and other objects, along with advantages and features of the present disclosure, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain principles of the embodiments discussed herein. No attempt is made to show structural details of this disclosure in more detail than can be necessary for a fundamental understanding of the embodiments discussed herein and the various ways in which they can be practiced. According to common practice, the various features of the drawings discussed below are not necessarily drawn to scale. Dimensions of various features and elements in the drawings can be expanded or reduced to more clearly illustrate embodiments of the disclosure.

FIG. 1 schematically illustrates an example heating assembly according to embodiments of the disclosure.

FIG. 2 schematically illustrates a partial perspective cross-sectional view of a plurality of heating elements and a plurality of heating tubes in an example arrangement for an electrically powered furnace according to embodiments of the disclosure.

FIG. 3 is a schematic partial section view of an example electrically powered furnace according to embodiments of the disclosure.

FIG. 4 is a schematic partial section view of another example electrically powered furnace according to embodiments of the disclosure.

FIG. 5 is a schematic partial perspective view of an electrically powered furnace having a heat input that varies along a length of the heating tubes according to embodiments of the disclosure.

FIG. 6A is a graph of the temperature of an inner diameter surface of an example heating tube as a function of position along the length of the heating tube for a furnace having a single column of heating tubes positioned between wall heaters.

FIG. 6B is a graph of the temperature of an inner diameter surface of an example heating tube as a function of position along the length of the heating tube for an example electrically powered furnace according to embodiments of the disclosure.

FIG. 7 is a block diagram of an example method to heat a feed by passing the feed through one or more heating tubes of an electrically powered furnace according to embodiments of the disclosure.

### DETAILED DESCRIPTION

The drawings may use like numerals to indicate like parts throughout the several views, the following description is provided as an enabling teaching of exemplary embodiments, and those skilled in the relevant art will recognize that many changes may be made to the embodiments described. It also will be apparent that some of the desired benefits of the embodiments described can be obtained by selecting some of the features of the embodiments without utilizing other features. Accordingly, those skilled in the art will recognize that many modifications and adaptations to the embodiments described are possible and may even be desirable in certain circumstances. Thus, the following description is provided as illustrative of the principles of the embodiments and not in limitation thereof.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to,” unless otherwise stated. Thus, the use of such terms is meant to encompass the items listed thereafter, and equivalents thereof, as well as additional items. The transitional phrases “consisting of” and “consisting essentially of,” are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish claim elements.

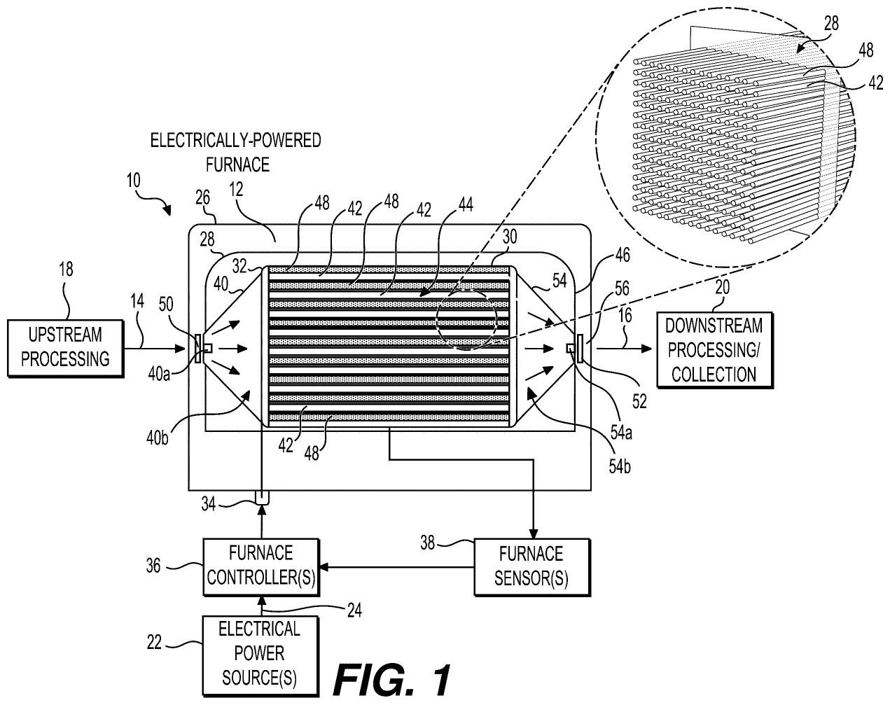

FIG. 1 is an example heating assembly 10 according to embodiments of the disclosure. As shown in FIG. 1, the heating assembly 10 may include an electrically powered furnace 12 for receiving a feed 14, which may include any material or materials that are heated during a heating process, and the electrically powered furnace 12 may heat the feed 14 to provide heated products 16, which may include precursors, intermediate products, and/or final products. In some embodiments, the electrically powered furnace 12 may be, or include, any electrically powered heater or heating device for heating a solid, fluid, gas, and/or combination thereof from a first temperature to a second temperature greater than the first temperature. In some embodiments, the electrically powered furnace 12 may be configured to convert electricity into heat sufficient to supply the heat of reaction for endothermic reactions. For example, the feed 14 may include hydrocarbons, and the heating assembly 10 may be a hydrocarbon heating assembly, such as, for example, an electrically powered cracking furnace to produce petroleum-derived products, which may include precursors, intermediate products, and/or final products, a steam methane reformer, a hydrocarbon heater for dehydrogenation, or any other process needing heat, for example, any application or process that is capable of accepting heat provided by high voltages and/or high temperatures. Other types of heating assemblies for heating other types of materials are contemplated.

In some embodiments, the heating assembly 10 shown in FIG. 1 may include upstream processing 18 prior to reaching the electrically powered furnace 12. For example, for heating assemblies 10 used to crack hydrocarbons, the upstream processing 18 may include, for example, a pre-heating section into which a hydrocarbon feed stream and a dilution stream may be supplied into pre-heating tubes for combining and pre-heating the hydrocarbon feed stream and the dilution stream, for example, as will be understood by those skilled in the art. For example, a hydrocarbon feed stream may include naphtha, ethane, and/or other hydrocarbons, and the electrically powered furnace 12 may at least partially crack the hydrocarbon feed stream to provide cracked hydrocarbons, which may include olefins, methane, and other by-products of the cracking process, as will be understood by those skilled in the art. Other types of upstream processes are contemplated.

As shown in FIG. 1, some embodiments of the heating assembly 10 may also include downstream processing/collection 20 for receiving the heated products 16, once the materials of the feed 14 have been heated in the electrically powered furnace 12 to provide the heated products 16. In some embodiments, the downstream processing/collection 20 may include additional processing and/or treatment of the heated products 16.

As shown in FIG. 1, in some embodiments, the electrically powered furnace 12 may be supplied with electrical power from one or more electrical power source(s) 22 via an electric power line 24. The electrical power source(s) 22 may include power generated independently from the heating assembly 10.

As shown in FIG. 1, the electrically powered furnace 12 may include a furnace housing 26 containing therein an electrically powered furnace section 28. For example, as shown in FIG. 1, the electrically powered furnace 12 may include a heating tube section 30, through which the material feed 14 flows during heating to output the heated products 16. As shown in FIG. 1, in some embodiments, the furnace section 28 may include a section housing 32 containing therein the heating tube section 30. In some embodiments, the furnace section 28 may be supplied with electrical power via the power line 24 via one or more terminals 34. The electrical power supplied to the electrically powered furnace 12 may be alternating current (AC) or direct current (DC).

As shown in FIG. 1, in some embodiments, the heating assembly 10 may include one or more furnace controllers 36 configured to control operation of the electrically powered furnace 12, for example, as will be understood by those skilled in the art. The heating assembly 10 may further include a plurality of furnace sensor(s) 38, such as, for example, voltage sensors, current sensors, temperature sensors, pressure sensors, flow rate sensors, etc., in communication with the furnace controller(s) 36, and the furnace controller(s) 36 may use control logic in the form of computer software and/or hardware programs to make control decisions associated with controlling operation of the electrically powered furnace 12. Some embodiments may include a transformer upstream of the furnace controller(s) 36 to bring the voltage down a level appropriate for operating the electrically powered furnace 12 as intended. In some embodiments, the power may be controlled, for example, via phase angle control, cross-over switching, on-off control, or other control schemes, as will be understood by those skilled in the art.

In some embodiments, the heating assembly 10 may include valves associated with the lines and/or conduits, and the furnace controller(s) 36 may communicate control signals based at least in part on the control decisions to control the voltage and/or current supplied to the electrically powered furnace 12, and/or to actuators associated with the valves to control the flow of the feed 14 (e.g., gases and/or liquids) and/or heat, and the actuators may be operated according to the communicated control signals to operate the electrically powered furnace 12 and/or other components of the heating assembly 10. In some examples, the furnace controller(s) 36 may be supplemented or replaced by human operators at least partially manually controlling the heating assembly 10 to meet desired performance parameters based at least in part on efficiency considerations and/or emissions considerations.

In some embodiments, as shown in FIG. 1, the furnace section 30 may include an input plenum 40 configured to receive the feed 14 entering the electrically powered furnace 12 and distribute the feed 14 to the heating tube section 30, including a plurality of heating tubes 42 extending in an interior volume 44 of the furnace housing 26 at least partially defined by one or more housing walls 46 of the furnace housing 26. For example, the input plenum 40 may include a single inlet tube 40a for supplying the feed 14 to an open cavity 40b for supplying the feed 14 from the inlet tube 40a to one or more of the heating tubes 42 and for distributing the feed 14 to the heating tube section 30, including a plurality of heating tubes 42. As shown in FIG. 1, the electrically powered furnace 12 also may include a plurality of heating elements 48 extending in the interior volume 44.

In some embodiments, each of the plurality of heating elements 48 may be electrically powered to radiate heat. The feed 14 may flow through the heating tubes 42 of the heating tube section 30, and the heating elements 48 may heat the heating tubes 42. For example, the heating tubes 42 may be positioned in the furnace housing 26 to receive heat radiated from the heating elements 48, for example, as described herein. Each of the of heating tubes 42 may define an interior passage positioned to receive the feed 14 and heat the feed 14 as the feed 14 passes through the interior passage between a tube inlet end 50 and the tube outlet end 52 of the heating tubes 42. At the end of the heating tubes 42, the heating tube section 30 may include an output plenum 54 in flow communication with the heating tubes 42 and configured to receive the heated products 16 and combine them from the plurality of heating tubes 42 into a single stream to exit the furnace section 28 via an output port 56. For example, the output plenum 54 may include an open cavity 54b for receiving the heated products 16 from one or more of the heating tubes 42 and supplying the heated products 16 to a single outlet tube 54a, which may pass the heated products 16 to the output port 56. In some embodiments, multiple furnace sections may be arranged in series, for example, to heat the feed 14 via more than one heating tube section. In some embodiments, not all the heating tubes 42 terminate at a single plenum and/or a single output port. In some embodiments, multiple furnace sections may be arranged parallel to one another.

Some embodiments of the electrically powered furnace 12 may include headers instead of, or in addition to, plenums. For example, the electrically powered furnace 12 may include an input header, which may include a single header inlet tube and a plurality of inlet header tubes. The header inlet tube may supply the feed 14 directly to the plurality of inlet header tubes, which supply the feed 14 from the header inlet tube directly to one or more of the heating tubes 42. In some embodiments, the number of inlet header tubes may substantially equal the number of heating tubes 42 of a given furnace section 28. The electrically powered furnace 12 may also include an output header, which may include a plurality of outlet header tubes and a single header outlet tube. The plurality of header outlet tubes may receive the heated products 16 directly from one or more of the heating tubes 42 and supply the heated products 16 to the single header outlet tube, which may pass the heated products 16 to the output port 56. In some embodiments, the number of outlet header tubes may substantially equal the number of heating tubes 42 of a given furnace section 28. It is contemplated that some embodiments of the electrically powered furnace 12 may include any combination of plenums and/or headers.

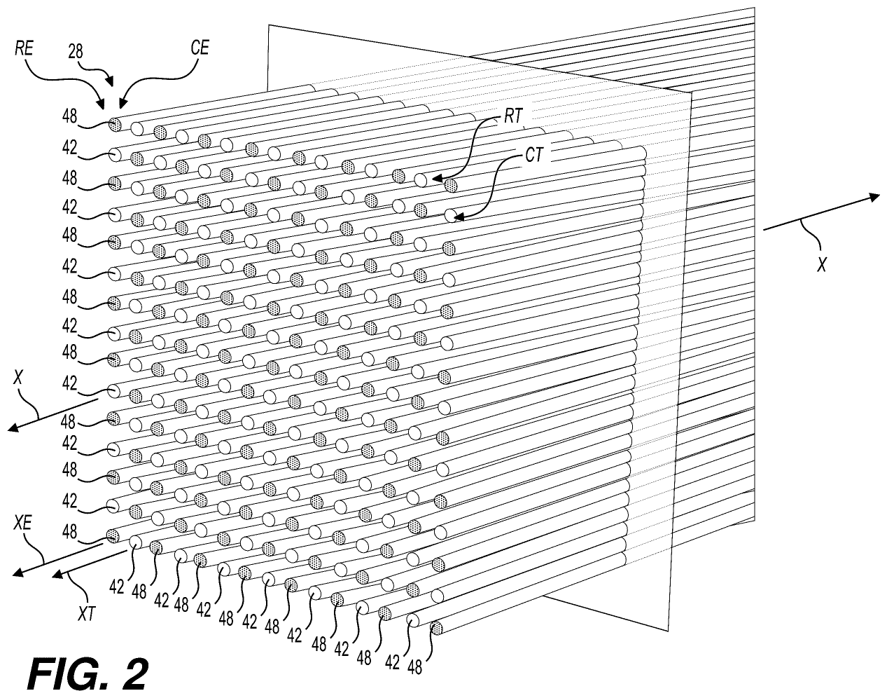

FIG. 2 schematically illustrates a partial perspective cross-sectional view of heating elements 48 and heating tubes 42 in an example arrangement for an electrically powered furnace 12 according to embodiments of the disclosure. As shown in FIG. 2, in some embodiments, the heating tubes 42 may be arranged in one or more of at least two rows RT or at least two columns CT and such that each of the heating tubes 42 is substantially equidistant from three or more of the heating elements 48. In some embodiments, the furnace section 28 may include a heating tube section 30 including the heating tubes 42, and the heating tubes 42 may be contained in the section housing 32. As shown in FIG. 2, in some embodiments, the heating tubes 42 may be substantially parallel to one another. In some embodiments, the heating elements 48 may be substantially parallel to one another.

In the embodiment shown in FIG. 2, the heating tube section 30 includes one-hundred twelve heating tubes 42 arranged in fifteen rows RT of heating tubes 42 and fifteen columns CT of heating tubes 42, and one-hundred thirteen heating elements 48 arranged in fifteen rows RE of heating elements 48 and fifteen columns CE of heating elements 42. Heating tube sections 30 having a different number of heating tubes 42 and/or a different arrangement of heating tubes 42 are contemplated. Heating tube sections 30 having a different number of heating elements 48 and/or a different arrangement of heating elements 48 are contemplated. In the embodiment of heating tube section 30 shown in FIG. 2, the heating tube section 30 is arranged such that the heating tubes 42 and the heating elements 48 are substantially horizontal. Some embodiments of heating tube section 30 may have different heating tube 42 and/or heating element 48 orientations, for example, ranging from horizontal to vertical.

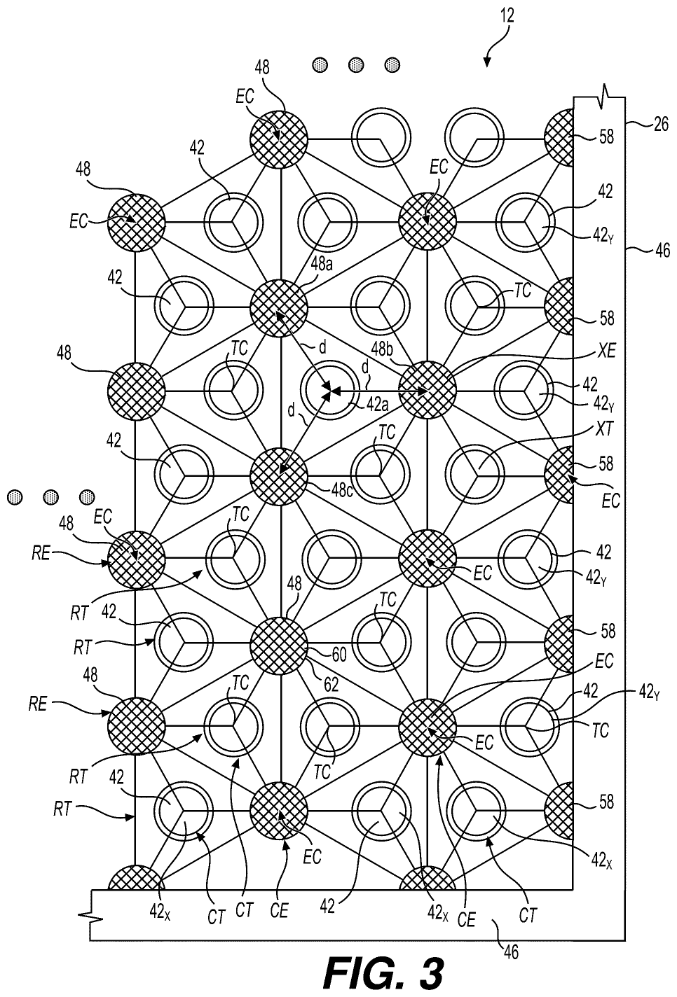

In some embodiments, a row RT of heating tubes 42 may include two or more heating tubes 42 arranged such that respective cross-sectional tube centers TC (see FIG. 3) of the heating tubes 42 lie in a substantially straight line. In some embodiments, a column CT of heating tubes 42 may include two or more heating tubes 42 arranged such that respective cross-sectional tube centers TC (see FIG. 3) of the heating tubes 42 lie in a substantially straight line. A row RE of heating elements 48 may include two or more heating elements 48 arranged such that respective cross-sectional element centers EC (see FIG. 3) of the heating elements 48 lie in a substantially straight line. In some embodiments, a column CE of heating elements 48 may include two or more heating elements 48 arranged such that respective cross-sectional element centers EC (see FIG. 3) of the heating elements 48 lie in a substantially straight line.

As shown in FIG. 2, in some embodiments, the heating elements 48 and the heating tubes 42 may be arranged such that, as viewed in a direction parallel to the longitudinal housing axis X, the heating elements 48 and/or the heating tubes 42 form a repeating pattern. For example, a unit of the repeating pattern may include one or more of the heating elements 48 per each of the heating tubes 42, for example, as shown in FIG. 2. In some embodiments, the unit of the repeating pattern may include two or more of the heating elements 48 per each of the heating tubes 42, three or more of the heating elements 48 per each of the heating tubes 42, four or more of the heating elements 48 per each of the heating tubes 42, five or more of the heating elements 48 per each of the heating tubes 42, or six or more of the heating elements 48 per each of the heating tubes 42. In some embodiments, the repeating pattern may include an equal number of heating tubes 42 and heating elements 48. In some embodiments, the repeating pattern may include two heating tubes 42 per heating element 48, three heating tubes 42 per heating element 48, or four or more heating tubes 42 per heating element 48. In some embodiments, the repeating pattern may include one or more of triangular, square, pentagonal, or hexagonal arrangements.

As shown in FIG. 2, in some embodiments, each of the heating elements 48 defines a longitudinal element axis XE, and each of the heating tubes 42 defines a longitudinal tube axis XT. In some such embodiments, at least a portion of the longitudinal element axis XE of each of the heating elements 48 may be substantially parallel to at least a portion of the longitudinal tube axis XT of each of the heating tubes 42. For example, in some embodiments, the longitudinal element axis XE of each of the heating elements 48 may be straight or curved, the longitudinal tube axis XT of each of the heating tubes 42 may be straight or curved, and/or the longitudinal element axis XE of each of the heating elements 48 may be substantially parallel to the longitudinal tube axis XT of each of the heating tubes 42. For example, the longitudinal element axis XE of each of the heating elements 48 may be straight, the longitudinal tube axis XT of each of the heating tubes 42 may be straight, and the longitudinal element axis XE of each of the heating elements 48 may be substantially parallel to the longitudinal tube axis XT of each of the heating tubes 42. In some embodiments, the longitudinal element axis XE of each of the heating elements 48 may be curved, the longitudinal tube axis XT of each of the heating tubes 42 may be curved, and at least a portion of the longitudinal element axis XE of each of the heating elements 48 may be substantially parallel to at least a portion of the longitudinal tube axis XT of each of the heating tubes 42. For example, the longitudinal element axis XE of each of the heating elements 48 may be U-shaped or W-shaped, the longitudinal tube axis XT of each of the heating tubes 42 may be U-shaped or W-shaped, and at least a portion of the longitudinal element axis XE of each of the heating elements 48 may be substantially parallel to at least a portion of the longitudinal tube axis XT of each of the heating tubes 42. For example, the heating tubes 42 and/or the heating elements 48 may be part of a U-tube furnace or W-tube furnace. In some embodiments, some of the heating tubes 42 and/or the heating elements 48 may be connected to other heating tubes 42 or heating elements 48, respectively, for example, through bends at one or both ends of the furnace 12.

FIG. 3 is a schematic partial section view of an example electrically powered furnace 12 according to embodiments of the disclosure. In some embodiments, each of the heating tubes 42 may be substantially equidistant from four or more of the heating elements 48, five or more of the heating elements 48, or six or more of the heating elements 48. For example, as shown in FIG. 3, each of the of the heating tubes 42 is substantially equidistant from three of the heating elements 48. For example, as shown, each of the heating elements 48a, 48b, and 48c is a respective distance d from the heating tube 42a, where each of the respective distances d is substantially equal. In some embodiments, the distance d may be measured from the respective centers of the heating tubes 42 and the heating elements 48, and/or from the respective outer surfaces of each of the heating tubes 42 and the heating elements 48.

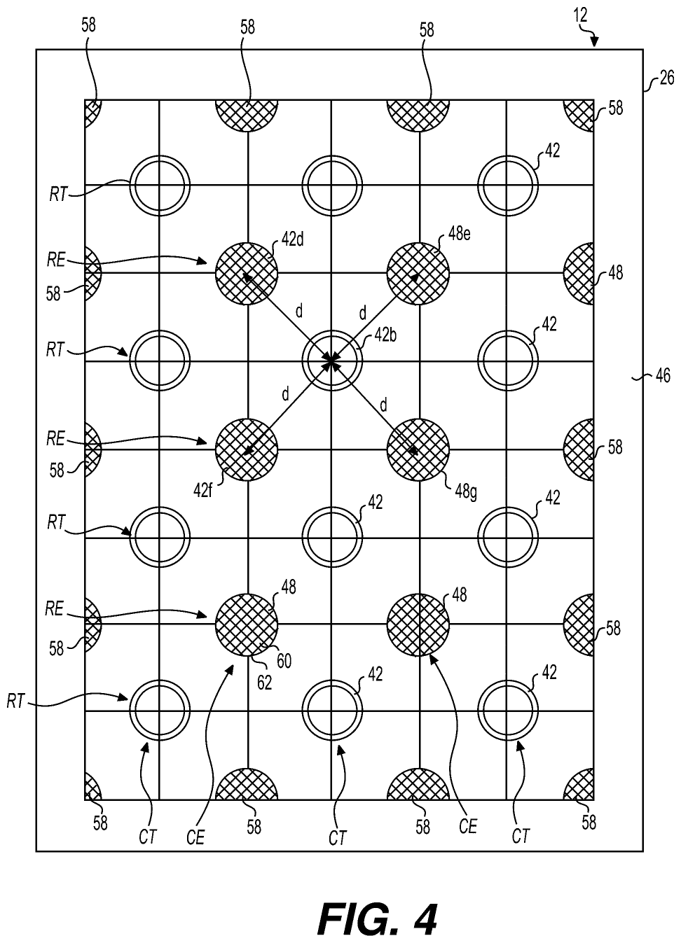

FIG. 4 is a schematic partial section view of another example electrically powered furnace 12 according to embodiments of the disclosure. As shown in FIG. 4, each of the heating tubes 42 is substantially equidistant from four of the heating elements 48. For example, as shown, each of the heating elements 48d, 48e, 48f, and 48g is a respective distance d from the heating tube 42b, where each of the respective distances dis substantially equal.

As shown in FIG. 3, one or more of the housing walls 46 may include one or more wall heating elements 58. In some embodiments, the one or more wall heating elements 58 may at least partially form a unit of a repeating pattern of the heating elements 48, for example, as shown in FIGS. 3 and 4. One or more of the wall heating elements 58 may include one or more radiative wall heating members. For example, one or more of the wall heating elements 58 may include one or more electrically-resistive wall heating members configured to radiate heat to one or more of the heating tubes 42 when activated.

The example heating tubes 42 and the example heating elements 48 shown in FIGS. 3 and 4 have circular cross-sections (or semi-circular cross-sections for the wall heating elements 58 at the housing walls 46). For example, as shown in FIGS. 3 and 4, in some embodiments, each of the heating elements 48 may include a core member 60 and a radiative heating member 62 on an outer surface of the core member 60. In some embodiments, the core member 60 may be rod-shaped, for example, having a circular cross-section or cross-sections of other shapes, for example square or rectangular in cross-section. For example, the core member 60 may be substantially cylindrical. In some embodiments, the core member 60 may include, or be formed from, refractory material. The radiative heating member 62 may be wrapped around the core member 60. In some embodiments, the radiative heating member 62 may be helically wrapped around the core member 60 and/or may extend longitudinally along the length of the core member 60. In some embodiments, not all of the core member 60 is covered with the radiative heating member 62, for example, so the heating element 48 may be supported or connected to the furnace 12. The radiative heating member 62 may include, or be formed from, an electrically-resistive element configured to radiate heat to the heating tubes 42 when electrically activated.

Although the example heating tubes 42 and the example heating elements 48 shown in FIGS. 3 and 4 have circular cross-sections (or semi-circular for heating elements 48 at the housing walls 46), the heating tubes 42 and/or the heating elements 48 may have cross-sectional shapes different than circular, such as, for example, oval-shaped, elliptical, square-shaped, rectangular-shaped, polygonal-shape, etc., for example, depending on desired heat transfer characteristics between the heating elements 48 and the heating tubes 42. In some embodiments, the heating elements 48 may include, or be formed from, a material or combination of materials, such that upon receipt of electrical power, the electrical impedance of the heating elements 48 causes the temperature of the heating elements 48 to increase to ranges of temperatures sufficient to heat the feed 14, which, in some embodiments, may cause endothermic reactions, for example, leading to the cracking of a hydrocarbon vapor.

As shown in FIG. 3, in some embodiments, the heating elements 48 may be arranged to form an ordered heating element pattern, and/or the heating tubes 42 may be arranged to form an ordered heating tube pattern. As shown in FIG. 3, the ordered heating element pattern may differ from the ordered heating tube pattern. As shown in FIG. 4, in some embodiments, the ordered heating element pattern may be substantially the same pattern as the ordered heating tube pattern. As shown in FIGS. 3 and 4, in some embodiments, the ordered heating tube pattern may include a first plurality of the heating tubes 42x arranged along a first axis and a second plurality of the heating tubes 42y arranged along a second axis perpendicular to the first axis, and one or more of the first plurality of heating tubes 42x or the second plurality of heating tubes 42y may include at least three heating tubes.

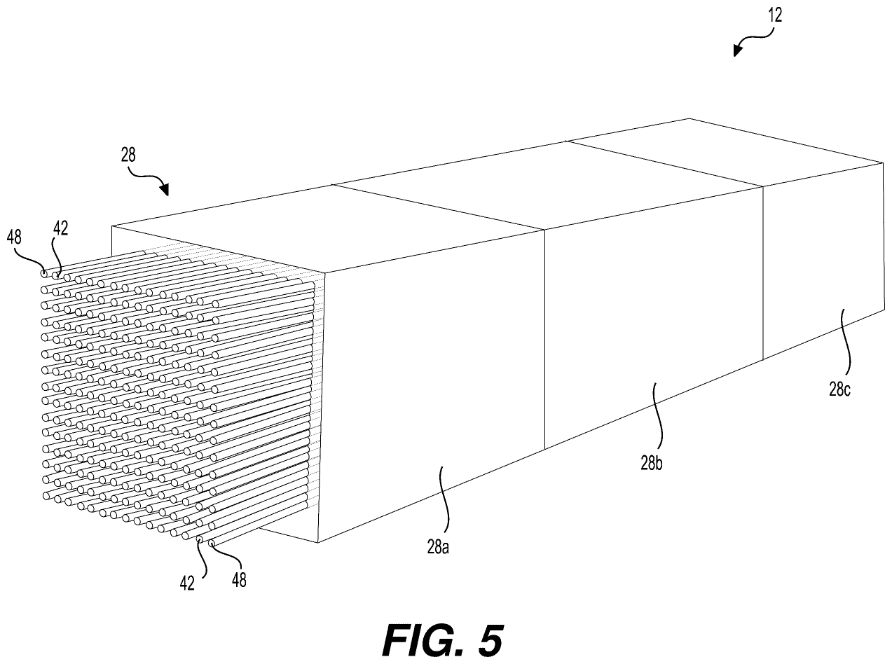

FIG. 5 is a schematic partial perspective view of an electrically powered furnace 12 having a heat input that varies along a length of the heating tubes 42 according to embodiments of the disclosure. As shown in FIG. 5, in some embodiments, heat input into each of the heating tubes 42 may vary along a length of the heating tube 42. For example, as schematically depicted in FIG. 5, the electrically powered furnace 12 may include more than one furnace section 28, and one or more of the furnace sections 28, may be configured to provide different heat inputs to the heating tubes 42. For example, as shown in FIG. 5, the electrically powered furnace 12 includes a first furnace section 28a, a second furnace section 28b, and a third furnace section 28c. Electrically powered furnaces 12 having fewer than three furnace sections or more than three furnace sections are contemplated. In some embodiments, the heat output of each of the plurality of heating elements 48 may vary along the length of each of the heating elements 48. In some embodiments, each of the plurality of heating elements 48 may include a plurality of heating element sections generally corresponding to a respective one of the furnace sections (e.g., furnace sections 28a, 28b, or 28c), and at least two of the plurality of heating element sections of each of the respective heating elements 48 may be configured to provide a different heat output, for example, via independent and/or coordinated electrical power input.

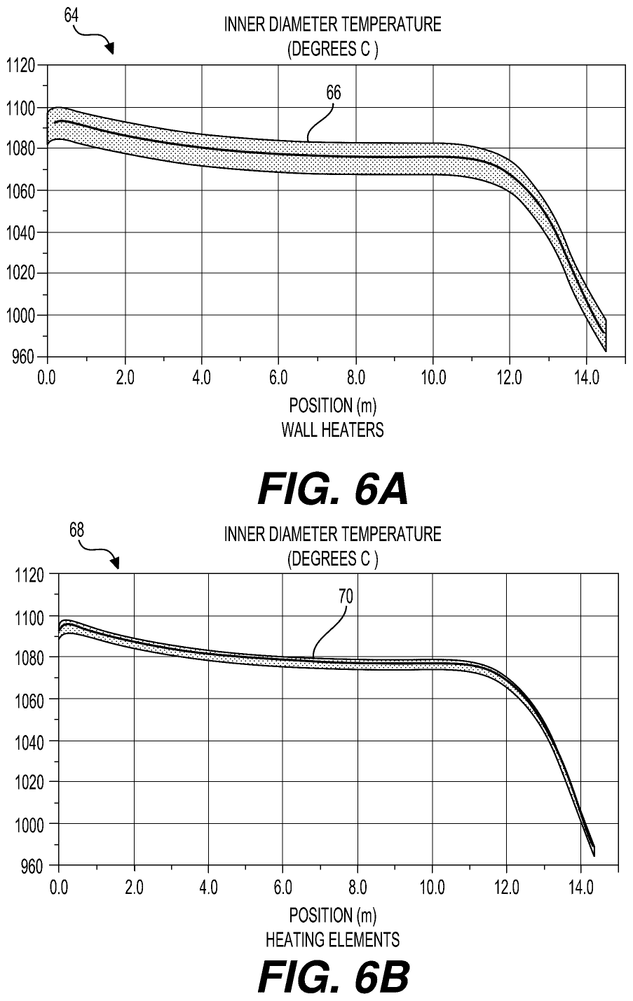

FIG. 6A is a graph 64 of the temperature 66 of an inner diameter surface of a heating tube as a function of position along the length of the heating tube for a furnace having a single column of heating tubes positioned between wall heaters associated with walls of the furnace. As mentioned previously herein, because the heating tubes receive heat input from two opposing sides only, the portions of the heating tubes adjacent the walls and wall heaters receive relatively more heat input than portions of the heating tubes not adjacent the walls. As a result, not all portions of the tubes are uniformly heated, which may result in non-uniform heating of the material passing through the tubes.

FIG. 6A schematically illustrates this phenomenon. The width of the line 66 depicting the inner diameter temperature of the heating tube shows the range of temperatures around the inner diameter of the heating tube as a function of the position along the length of the heating tube. For example, at the position along the length of the heating tube corresponding to 2.0 meters, the temperature varies from about 1075 degrees C. to about 1095 degrees C., corresponding to a temperature differential of about 20 degrees C. As noted above, depending on the material being heated and the temperatures involved, this may lead to problems with the heated material or the heating tubes. For example, in order to ensure that all the material passing through the heating tube is heated to a sufficient temperature, even the portion of the material adjacent the relatively cooler portions of the heating tube, it may be necessary to increase the heat input beyond what would be sufficient to heat the portion of the material adjacent the relatively hotter portions of the heating tube. This may lead to overheating a portion of the material, which may create unsatisfactory material properties (e.g., premature or excessive coking of a hydrocarbon feed or a negative impact on product yields) and/or may lead to premature wear or damage to the heating tube due to excessively high temperature.

FIG. 6B is a graph 68 of the temperature 70 of an inner diameter surface of an example heating tube 42 as a function of position along the length of the heating tube 42 for an example electrically powered furnace 12 according to embodiments of the disclosure. Instead of a furnace having a single column of heating tubes positioned between wall heaters associated with walls of the furnace, the furnace corresponding to the graph 68 shown in FIG. 6B is consistent with the electrically powered furnaces 12 according to embodiments of the disclosure described herein. As compared the temperature line 66 shown in FIG. 6A, the temperature line 70 shown in FIG. 6B is relatively more narrow. This illustrates that the temperature differential around the inner diameter (e.g., circumferentially around the inner surface of the heating the 42) is less than the temperature differential for the inner diameter shown in in FIG. 6A. For example, for the example heating tube 42 of FIG. 6B, at the position along the length of the heating tube 42 corresponding to 2.0 meters, the temperature varies from about 1085 degrees C. to about 1090 degrees C., corresponding to a temperature differential of about 5 degrees C. Relative to the 20-degree C. temperature differential shown in FIG. 6A at the same position along the length of the heating tube, the temperature differential shown in FIG. 6B is about 75% less than the temperature differential shown in FIG. 6B.

Each of the heating tubes 42 according to embodiments of the disclosure defines a tube perimeter. In some embodiments, the heating elements 48 and the heating tubes 42 may be arranged such that heat input to each of the heating tubes is substantially uniform around the perimeter of each of the heating tubes 42. For example, in some embodiments, a surface temperature of each of the heating tubes 42 may vary about 1.5 percent or less around the tube perimeter over at least sixty percent of a length of the heating tube 42. In some embodiments, the surface temperature of each of the heating tubes may vary about 1.5 percent or less around the tube perimeter over at least seventy percent of the length of the heating tube 42, the surface temperature of each of the heating tubes 42 may vary about 1.0 percent or less around the tube perimeter over at least seventy-five percent of the length of the heating tube 42, or the surface temperature of each of the heating tubes 42 may vary about 1.0 percent or less around the tube perimeter over at least eighty percent of the length of the heating tube 42.

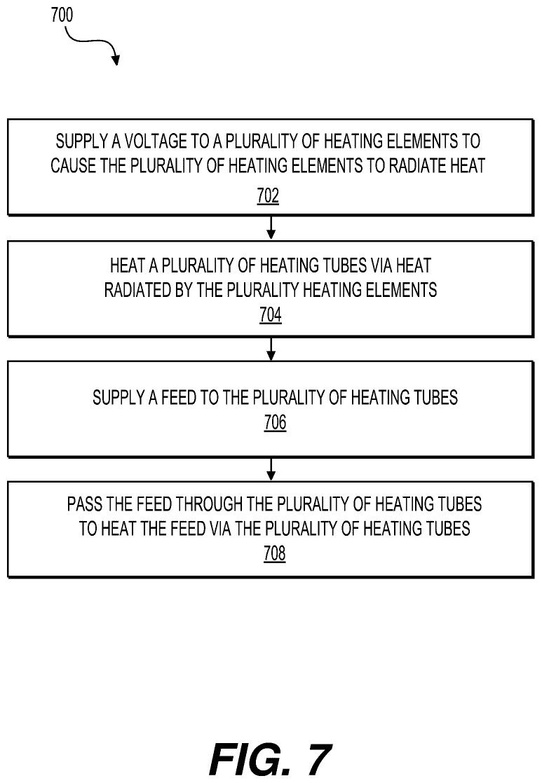

FIG. 7 is a block diagram of an example method 700 to heat a material feed, according to embodiments of the disclosure, illustrated as a collection of blocks in a logical flow graph, which represent a sequence of operations. The order in which the operations are described is not intended to be construed as a limitation, and any number of the described blocks may be combined in any order and/or in parallel to implement the method.

FIG. 7 is a block diagram of an example method 700 to heat a material feed by passing the material feed through one or more heating tubes of an electrically powered furnace, according to embodiments of the disclosure. For example, the material feed may include, but is not limited to, hydrocarbons, and the heating of the material feed may be part of a process to crack the hydrocarbons, for example, as part of a hydrocarbon cracking process, part of a methane reforming process, or as part of a dehydrogenation process. Other types of feeds and/or heating processes are contemplated.

The example method 700, at 702, may include supplying a voltage to a plurality of heating elements to cause the plurality of heating elements to radiate heat. For example, the plurality of heating elements may be positioned in an interior volume of a furnace housing, as described previously herein.

At 704, the example method 700 also may include heating a plurality of heating tubes via heat radiated by the plurality of heating elements. For example, the plurality of heating tubes may be positioned in the furnace housing, as described previously herein. The plurality of heating tubes may be arranged in one or more of at least two rows or at least two columns and such that each of the plurality of heating tubes is substantially equidistant from three or more of the plurality of heating elements. In some embodiments, the heating elements may be configured to radiate heat when activated by suppling electrical power to the heating elements. The heat radiated by the heating elements may provide heat input to the heating tubes, for example, as previously described herein.

The example method 700, at 706, further may include supplying a feed to the plurality of heating tubes. For example, each of the heating tubes may define an interior passage positioned to receive the feed and heat the feed as the feed passes through the interior passage between a tube inlet end and a tube outlet end. As mentioned herein, the feed may include hydrocarbons, and the heating of the feed may be part of a process to crack the hydrocarbons, for example, as part of a hydrocarbon cracking process, part of a methane reforming process, or as part of a dehydrogenation process.

At 708, the example method 700 may include passing the feed through the plurality of heating tubes to heat the feed via the plurality of heating tubes. For example, the heat radiated by the heating elements may provide heat input to the heating tubes, as previously described herein. As the feed passes through the interior passage of the heating tubes, the feed may be heated.

An example electrically powered furnace A to heat a feed may include a furnace housing including one or more housing walls at least partially defining an interior volume and a longitudinal housing axis. The example furnace also may include a plurality of heating elements extending in the interior volume and between a first heating element end and a second heating element end, each of the plurality of heating elements being electrically powered to radiate heat. The example furnace A further may include a plurality of heating tubes extending in the interior volume and between a tube inlet end and a tube outlet end, each of the plurality of heating tubes defining an interior passage positioned to receive the feed and heat the feed as the feed passes through the interior passage between the tube inlet end and the tube outlet end. The plurality of heating tubes may be positioned in the furnace housing to receive heat radiated from the plurality of heating elements, and the plurality of heating tubes may be arranged in one or more of at least two rows or at least two columns and such that each of the plurality of heating tubes is substantially equidistant from three or more of the plurality of heating elements.

The example furnace A above, wherein one or more of: a row of heating tubes includes two or more heating tubes of the plurality of heating tubes arranged such that respective cross-sectional tube centers of the two or more heating tubes lie in a straight line; or a column of heating tubes includes two or more heating tubes of the plurality of heating tubes arranged such that respective cross-sectional tube centers of the two or more heating tubes lie in a straight line.

The example furnace A above, wherein the plurality of heating elements and the plurality of heating tubes are arranged such that, as viewed in a direction parallel to the longitudinal housing axis, the plurality of heating elements and the plurality of heating tubes form a repeating pattern.

The example furnace A above, wherein a unit of the repeating pattern includes an equal number of the plurality of heating tubes and the plurality of heating elements, two or more heating tubes of the plurality of heating tubes per each of the plurality of heating elements, three or more heating tubes of the plurality of heating tubes per each of the plurality of heating elements, four or more heating tubes of the plurality of heating tubes per each of the plurality of heating elements, two or more of the plurality of heating elements per each of the plurality of heating tubes, three or more of the plurality of heating elements per each of the plurality of heating tubes, four or more of the plurality of heating elements per each of the plurality of heating tubes, five or more of the plurality of heating elements per each of the plurality of heating tubes, or six or more of the plurality of heating elements per each of the plurality of heating tubes.

The example furnace A above, wherein a unit of the repeating pattern includes non-integer ratios of heating elements per heating tubes, such as, but not limited to 3:2, 5:2, 5:3, 5:4, etc.

The example furnace A above, wherein: each of the plurality of heating elements defines a longitudinal element axis; each of the plurality of heating tubes defines a longitudinal tube axis; and at least a portion of the longitudinal element axis of each of the plurality of heating elements is parallel to at least a portion of the longitudinal tube axis of each of the plurality of heating tubes.

The example furnace A above, wherein one or more of: the longitudinal element axis of each of the plurality of heating elements is one or more of straight or curved; the longitudinal tube axis of each of the plurality of heating tubes is one or more of straight or curved; or the longitudinal element axis of each of the plurality of heating elements is substantially parallel to the longitudinal tube axis of each of the plurality of heating tubes.

The example furnace A above, wherein each of the plurality of heating tubes is substantially equidistant from four or more of the plurality of heating elements, five or more of the plurality of heating elements, or six or more of the plurality of heating elements.

The example furnace A above, wherein one or more of the housing walls include one or more wall heating elements, and one or more of: one or more of the wall heating elements include one or more radiative wall heating members; or one or more of the wall heating elements include one or more electrically-resistive wall heating members configured to radiate heat to the heating tubes when activated.

The example furnace A above, wherein each of the plurality of heating elements includes a core member and a radiative heating member on an outer surface of the core member; and one or more of: the core member is rod-shaped; the core member is substantially cylindrical; the core member comprises refractory material; the radiative heating member is wrapped around the core member; the radiative heating member is helically wrapped around the core member; or the radiative heating member comprises an electrically-resistive element configured to radiate heat to the heating tubes when activated.

The example furnace A above, wherein the plurality of heating elements form an ordered heating element pattern, and the plurality of heating tubes form an ordered heating tube pattern; and one or more of: the ordered heating element pattern is the same pattern as the ordered heating tube pattern; or the ordered heating element pattern differs from the ordered heating tube pattern.

The example furnace A above, wherein the ordered heating tube pattern includes a first plurality of the plurality of heating tubes arranged along a first axis and a second plurality of the plurality of heating tubes arranged along a second axis perpendicular to the first axis, and one or more of the first plurality of heating tubes or the second plurality of heating tubes includes at least three heating tubes.

The example furnace A above, wherein each of the plurality of heating tubes defines a tube perimeter, and the plurality of heating elements and the plurality of heating tubes are arranged such that heat input to each of the plurality of heating tubes is substantially uniform around the perimeter of each of the plurality the heating tubes.

The example furnace A above, wherein a surface temperature of each of the plurality of heating tubes varies 1.5 percent or less around the tube perimeter over at least sixty percent of a length of the heating tube, a surface temperature of each of the plurality of heating tubes varies 1.5 percent or less around the tube perimeter over at least seventy percent of the length of the heating tube, a surface temperature of each of the plurality of heating tubes varies 1.0 percent or less around the tube perimeter over at least seventy-five percent of the length of the heating tube, or a surface temperature of each of the plurality of heating tubes varies 1.0 percent or less around the tube perimeter over at least eighty percent of the length of the heating tube. For clarity, the variation is relative to absolute temperatures (e.g., K or C).

The example furnace A above, wherein one or more of: heat input into each of the heating tubes varies along a length of the heating tube; heat output of each of the plurality of heating elements varies along the length of each of the heating elements; or each of the plurality of heating elements comprises a plurality of heating element sections, and at least two of the plurality of heating element sections of each of the plurality of heating elements provides a different heat output.

An example hydrocarbon heating assembly B may include the example electrically powered furnace A above, wherein the electrically powered furnace is one of a steam cracking furnace, a steam methane reformer, or a hydrocarbon heater for dehydrogenation.

A method to heat a feed may include supplying a feed to a plurality of heating tubes; heating the plurality of heating tubes via a plurality of heating elements, the plurality of heating tubes being arranged in one or more of at least two rows or at least two columns and such that each of the plurality of heating tubes is substantially equidistant from three or more of the plurality of heating elements; and heating the feed, and in some instances, supplying heat of reaction, via the plurality of heating tubes as the feed passes through the heating tubes.

Having now described some illustrative embodiments of the disclosure, it should be apparent to those skilled in the art that the foregoing is merely illustrative and not limiting, having been presented by way of example only. Numerous modifications and other embodiments are within the scope of one of ordinary skill in the art and are contemplated as falling within the scope of the disclosure. In particular, although many of the examples presented herein involve specific combinations of method acts or system elements, it should be understood that those acts and those elements may be combined in other ways to accomplish the same objectives. Those skilled in the art should appreciate that the parameters and configurations described herein are exemplary and that actual parameters and/or configurations will depend on the specific application in which the systems and techniques of the disclosure are used. Those skilled in the art should also recognize or be able to ascertain, using no more than routine experimentation, equivalents to the specific embodiments of the disclosure. It is, therefore, to be understood that the embodiments described herein are presented by way of example only and that, within the scope of any appended claims and equivalents thereto, the embodiments of the disclosure may be practiced other than as specifically described.

Furthermore, the scope of the present disclosure shall be construed to cover various modifications, combinations, additions, alterations, etc., above and to the above-described embodiments, which shall be considered to be within the scope of this disclosure. Accordingly, various features and characteristics as discussed herein may be selectively interchanged and applied to other illustrated and non-illustrated embodiment, and numerous variations, modifications, and additions further can be made thereto without departing from the spirit and scope of the present disclosure as set forth in the appended claims.

What is claimed is:

1. An electrically powered furnace to heat a feed, the electrically powered furnace comprising:
a furnace housing comprising one or more housing walls at least partially defining an interior volume and a longitudinal housing axis;
a plurality of heating elements extending in the interior volume and between a first heating element end and a second heating element end, each of the plurality of heating elements being electrically powered to radiate heat; and
a plurality of heating tubes extending in the interior volume and between a tube inlet end and a tube outlet end, each of the plurality of heating tubes defining an interior passage positioned to receive the feed and heat the feed as the feed passes through the interior passage between the tube inlet end and the tube outlet end, and the plurality of heating tubes being positioned in the furnace housing to receive heat radiated from the plurality of heating elements,
the plurality of heating tubes being arranged in one or more of at least two rows or at least two columns and such that each of the plurality of heating tubes is substantially equidistant from three or more of the plurality of heating elements.

2. The electrically powered furnace of claim 1, wherein one or more of:
a row of heating tubes comprises two or more heating tubes of the plurality of heating tubes arranged such that respective cross-sectional tube centers of the two or more heating tubes lie in a straight line; or
a column of heating tubes comprises two or more heating tubes of the plurality of heating tubes arranged such that respective cross-sectional tube centers of the two or more heating tubes lie in a straight line.

3. The electrically powered furnace of claim 1, wherein the plurality of heating elements and the plurality of heating tubes are arranged such that, as viewed in a direction parallel to the longitudinal housing axis, the plurality of heating elements and the plurality of heating tubes form a repeating pattern.

4. The electrically powered furnace of claim 3, wherein a unit of the repeating pattern comprises an equal number of the plurality of heating tubes and the plurality of heating elements, two or more heating tubes of the plurality of heating tubes per each of the plurality of heating elements, three or more heating tubes of the plurality of heating tubes per each of the plurality of heating elements, four or more heating tubes of the plurality of heating tubes per each of the plurality of heating elements, two or more of the plurality of heating elements per each of the plurality of heating tubes, three or more of the plurality of heating elements per each of the plurality of heating tubes, four or more of the plurality of heating elements per each of the plurality of heating tubes, five or more of the plurality of heating elements per each of the plurality of heating tubes, six or more of the plurality of heating elements per each of the plurality of heating tubes, or non-integer ratios of heating elements per heating tubes.

5. The electrically powered furnace of claim 1, wherein:
each of the plurality of heating elements defines a longitudinal element axis;
each of the plurality of heating tubes defines a longitudinal tube axis; and
at least a portion of the longitudinal element axis of each of the plurality of heating elements is parallel to at least a portion of the longitudinal tube axis of each of the plurality of heating tubes.

6. The electrically powered furnace of claim 5, wherein one or more of:
the longitudinal element axis of each of the plurality of heating elements is one or more of straight or curved;
the longitudinal tube axis of each of the plurality of heating tubes is one or more of straight or curved; or
the longitudinal element axis of each of the plurality of heating elements is substantially parallel to the longitudinal tube axis of each of the plurality of heating tubes.

7. The electrically powered furnace of claim 1, wherein each of the plurality of heating tubes is substantially equidistant from four or more of the plurality of heating elements, five or more of the plurality of heating elements, or six or more of the plurality of heating elements.

8. The electrically powered furnace of claim 1, wherein one or more of the housing walls comprise one or more wall heating elements; and
one or more of:
one or more of the wall heating elements comprise one or more radiative wall heating members; or
one or more of the wall heating elements comprise one or more electrically-resistive wall heating members configured to radiate heat to the heating tubes when activated.

9. The electrically powered furnace of claim 1, wherein each of the plurality of heating elements comprises a core member and a radiative heating member on an outer surface of the core member; and
one or more of:
the core member is rod-shaped;
the core member is substantially cylindrical;
the core member comprises refractory material;
the radiative heating member is wrapped around the core member;
the radiative heating member is helically wrapped around the core member; or
the radiative heating member comprises an electrically-resistive element configured to radiate heat to the heating tubes when activated.

10. The electrically powered furnace of claim 1, wherein the plurality of heating elements form an ordered heating element pattern and the plurality of heating tubes form an ordered heating tube pattern; and
the ordered heating element pattern is the same pattern as the ordered heating tube pattern; or
the ordered heating element pattern differs from the ordered heating tube pattern.

11. The electrically powered furnace of claim 1, wherein:
each of the plurality of heating tubes defines a tube perimeter; and
the plurality of heating elements and the plurality of heating tubes are arranged such that heat input to each of the plurality of heating tubes is substantially uniform around the perimeter of each of the plurality the heating tubes.

12. The electrically powered furnace of claim 11, wherein a surface temperature of each of the plurality of heating tubes varies 1.5 percent or less around the tube perimeter over at least sixty percent of a length of the heating tube, a surface temperature of each of the plurality of heating tubes varies 1.5 percent or less around the tube perimeter over at least seventy percent of the length of the heating tube, a surface temperature of each of the plurality of heating tubes varies 1.0 percent or less around the tube perimeter over at least seventy-five percent of the length of the heating tube, or a surface temperature of each of the plurality of heating tubes varies 1.0 percent or less around the tube perimeter over at least eighty percent of the length of the heating tube.

13. The electrically powered furnace of claim 1, wherein one or more of:
heat input into each of the heating tubes varies along a length of the heating tube;
heat output of each of the plurality of heating elements varies along the length of each of the heating elements; or
each of the plurality of heating elements comprises a plurality of heating element sections, and at least two of the plurality of heating element sections of each of the plurality of heating elements provides a different heat output.

14. A hydrocarbon heating assembly comprising:
the electrically powered furnace of claim 1,
wherein the electrically powered furnace comprises one of a steam cracking furnace, a steam methane reformer, or a hydrocarbon heater for dehydrogenation.

15. A method to heat a feed, the method comprising:
supplying a feed to a plurality of heating tubes;
heating the plurality of heating tubes via a plurality of heating elements, the plurality of heating tubes being arranged in one or more of at least two rows or at least two columns and such that each of the plurality of heating tubes is substantially equidistant from three or more of the plurality of heating elements; and
heating the feed via the plurality of heating tubes as the feed passes through the heating tubes.
